(19) United States
(12) Patent Application Publication
(10) Pub. No.: US 2026/0339987 A1
(43) Pub. Date: Oct. 29, 2026

(54) EFFICIENT DOMAIN MODEL GENERATION

(71) Applicant: Salesforce, Inc., San Francisco, CA (US)

(72) Inventors: Nikhil KAPRE, Bengaluru (IN); Tarundeep BATRA, San Francisco, CA (US); Jayakrishnan Radhakrishna PILLAI, Bengaluru (IN)

(21) Appl. No.: 19/191,359

(22) Filed: Apr. 28, 2025

(51) Int. Cl. G06F 16/332; G06F 16/25; G06F 16/353

(52) U.S. Cl. CPC G06F 16/3322; G06F 16/258; G06F 16/353

(57) ABSTRACT

Systems, devices, and techniques are disclosed for an efficient domain model generation. Electronic documents including data associated with domains may be received into a domain knowledge repository. A user request to generate a domain model may be received. A domain of the domains for which to generate the domain model may be determined based on the user request. Queries may be generated to be run against the domain knowledge repository based on the determined domain. Data for the domain model may be received by running the queries against the domain knowledge repository using a machine learning system. The domain model may be generated from the data for the domain model by performing formatting steps and transformation steps on the data for the domain model using the machine learnings system.

### BACKGROUND

Domain model generation for software construction or implementation may be time consuming and dependent on the judgement of domain experts. The development of a domain model may also be iterative, requiring several rounds of discussions to refine a domain model before it is ready for use. This may result in domain models taking months to generate. Miscommunication or incomplete knowledge from domain experts can lead to inaccurate domain models. Changing requirements for a domain model may necessitate continuous updates to an already generated domain model, making alignment resource-intensive.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows an example system suitable for efficient domain model generation according to an implementation of the disclosed subject matter.

FIG. 2 shows an example arrangement suitable for efficient domain model generation according to an implementation of the disclosed subject matter.

FIG. 3 shows an example arrangement suitable for efficient domain model generation according to an implementation of the disclosed subject matter.

FIG. 4 shows an example arrangement suitable for efficient domain model generation according to an implementation of the disclosed subject matter.

FIG. 5 shows an example procedure suitable for efficient domain model generation according to an implementation of the disclosed subject matter.

FIG. 6 shows an example procedure suitable for efficient domain model generation according to an implementation of the disclosed subject matter.

FIG. 7 shows a computer according to an implementation of the disclosed subject matter.

FIG. 8 shows a network configuration according to an implementation of the disclosed subject matter.

### DETAILED DESCRIPTION

Techniques disclosed herein enable efficient domain model generation, which may allow domain models to be generated quickly and automatically based on user requests and to be adjusted based on user feedback. Electronic documents including data associated with domains may be received into a domain knowledge repository. A user request to generate a domain model may be received. A domain of the domains for which to generate the domain model may be determined based on the user request. Queries may be generated to be run against the domain knowledge repository based on the determined domain. Data for the domain model may be received by running the one or more queries against the domain knowledge repository using a machine learning system. The domain model may be generated from the data for the domain model by performing one or more formatting steps and transformation steps on the data for the domain model using the machine learnings system.

Electronic documents including data associated with domains may be received into a domain knowledge repository. The electronic documents may be in any suitable format, including, for example, PDF, TXT, HTML, and CSV formats. The electronic documents may be received from any suitable sources, including publicly available sources, and may be received in any suitable manner, including through crawling of publicly available sources and through submission by, for example, domain experts. In some implementations, the electronic documents may be retrieved by a machine learning system, such as a large language model (LLM), based on a query submitted to the machine learning system to find electronic documents that pertain to specific domains, for example, business types, industries, culture, research or scientific domains.

A user request to generate a domain model may be received. The request may be a request to generate a domain model for a specified domain, for example, specified industry, business, cultural, research, or scientific domain. The request may be received from, for example, a user involved in the construction and/or implementation of software that will rely on the domain model to express the meanings of and relationships between terms and concepts used in the specified domain. For example, a user involved in constructing software for use in a hospital may request a domain model for the health care industry. The request may also specify customizations to the domain model, such as, for example, a geographic location where software using the domain model will be deployed. The request may be received at any suitable system, such as, for example, a machine learning system such as an LLM.

A domain of the domains for which to generate the domain model may be determined based on the user request. The domain knowledge repository may include electronic documents for any number of different domains. A specific domain for which a domain model should be generated may be determined from among the domains for which the domain knowledge repository includes electronic documents based on the request received from the user. The domain for which the domain model should be generated may be determined in any suitable manner. The request may, for example, include a direct specification of a domain for which the domain knowledge repository already includes electronic documents, such as specifying that the domain model should be generated for the health care industry. The request may also be interpreted, for example, by an LLM, to determine which domain for which the domain knowledge repository already includes electronic documents best matches the intent of the request, for example, specifying that domain model is needed for software that will be used in a hospital environment. In some implementations, if there are no electronic documents in the domain knowledge repository that are from the domain determined from the user request, additional electronic documents for the determined domain may be retrieved by, for example, an LLM from any suitable sources and added to the domain knowledge repository.

Queries may be generated to be run against the domain knowledge repository based on the determined domain. The queries may be queries that may be submitted to an LLM to be run against the domain knowledge repository. The queries may be generated by, for example, an LLM based on the determined domain for which the domain model will be generated along with any customizations specified in the user request that may provide additional context to the domain model. The queries may be, for example, requests for data related to the determined data from the electronic documents in the domain knowledge repository filtered based on a geographic location specified in the user request. For example, the queries may request data related to the health care domain filtered to be relevant to the United States. This may ensure, for example, that the data from the domain knowledge repository received in response to the queries may include concepts and terminology used in health care in the United States and may exclude concepts and terminology used in other geographic locations and not in the United States.

Data for the domain model may be received by running the one or more queries against the domain knowledge repository using a machine learning system. The generated queries may be run against the domain knowledge repository by, for example, an LLM. Data that is responsive to the queries may be received from the electronic documents in the domain knowledge repository in response to the running of the queries. For example, if the queries request data related to health care in the United States, the LLM running the queries against the domain knowledge repository may result in the LLM receiving data for terms and concepts that used in the health care in the United States from the electronic documents in the domain knowledge repository.

The domain model may be generated from the data for the domain model by performing one or more formatting steps and transformation steps on the data for the domain model using the machine learnings system. The data for the domain model received from the domain knowledge repository may be used to generate the domain model through formatting and transformation of the received data. The formatting and transformation may be performed by, for example, an LLM. The domain model may be output in any suitable format, including, for example, plain text format or JSON format. The generated domain model may include, for example, business entities and their related documentation, entity attributes, attribute data types, attribute constraints such as whether attributes are unique or not null, entity relationships which may indicated through the use of foreign keys, and relationship cardinality.

The domain model may be sent to a user. For example, the domain model may be sent to the user who supplied the user request that resulted in the generation of the domain model. The user may review the domain model. If the user does not think the domain model is correct, the user may provide an indication that the domain model is incorrect. The indication may be provided to, for example, the system, for example, LLM, to which the user request that resulted in the generation of the domain model was sent. The indication may include a description of the reason the user believes the domain model is incorrect written in natural language. The indication from the user and the domain model may be used, for example, by an LLM, to generate new queries that may be run against domain knowledge repository to retrieve new data that may be used to generate a new version of the domain model that may address the reason the user indicated the domain model was incorrect. For example, the user may indicate that the domain model was incorrect because it included data that was not relevant to the geographic area that the domain model will be used in. The queries generated in response to the indication from the user may, for example, request data for the domain that is relevant in the geographic area of interest to the user and specifically exclude data that is from other geographic areas to ensure that the new version of the domain model is based only on data relevant to the correct geographic area. The data retrieved from the domain knowledge repository based on the new queries may be used to generate the new version of the domain model which may be sent back to the user for further review. If the user believes the new version of the domain model is incorrect, the user may again provide an indication that the domain model is incorrect to the LLM which may generate more new queries to be used to retrieve data to generate another new version of the domain model. This feedback loop may continue until the user believes the domain model is correct and can be used in the intended software construction or implementation.

Additional electronic documents may be received in the domain knowledge repository. The domain knowledge repository may be continually updated with new electronic documents pertaining to various domains. The new electronic documents may be obtained in any suitable manner, including, for example, through submission to the domain knowledge repository by subject matter experts or through continuous crawling of external sources. The new electronic documents may be new or may be updated versions of electronic documents already in the domain knowledge repository.

A suggested update to a domain model may be generated based on the additional electronic documents. As new electronic documents are added to the domain knowledge repository, the new electronic documents may be evaluated to determine if they include data that can be used to update any already-generated domain models. For example, a new electronic document added to the domain knowledge repository may be determined to include data relevant to a specific domain, such as health care. The data in the new electronic document may be used to generate a suggested update to any domain models that were generated for the domain to which the data in the new electronic document is relevant. The suggested update may be, for example, the addition of data from the new electronic document to the domain model or may be the updating of data already in the domain model based on the data in the new electronic document. The update may be suggested by, for example, the LLM used to generate the domain model. The suggested update to the domain model may be applied to the domain model automatically or may be subject to user review and approval before being used to update the domain model. Suggested updates to already-generated domain models may be generated continually as new electronic documents are added to the domain knowledge repository. This may allow for domain models to remain relevant and up-to-date even after they have been generated without requiring that the entire domain model be regenerated.

Domain models may be generated, and user feedback may be used to correct issues with domain models, in this manner faster and more efficiently than domain model creation and correction by subject matter experts. Domain models may be updated faster and more frequently in response to new data relevant to the domains of the domain models.

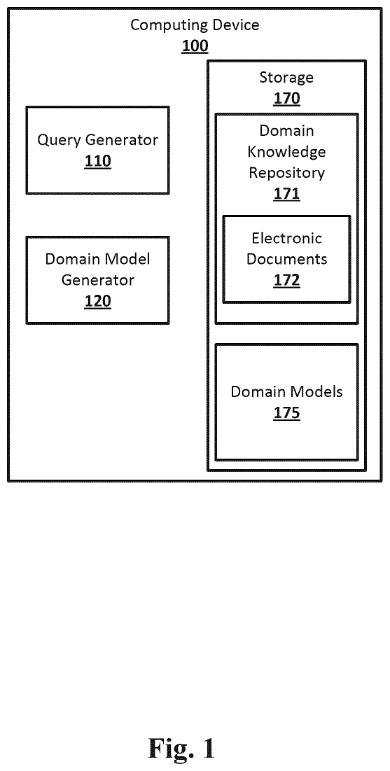

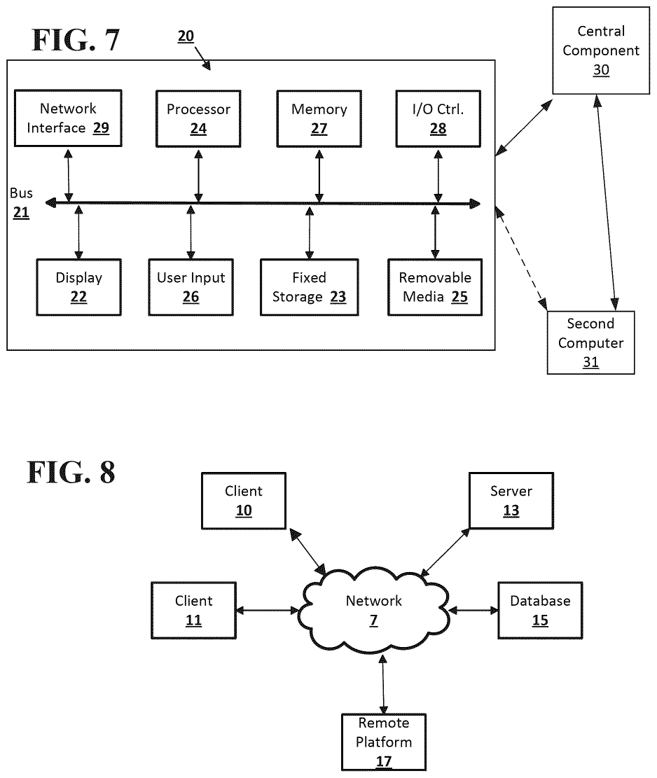

FIG. 1 shows an example system suitable for efficient domain model generation according to an implementation of the disclosed subject matter. A computing device 100 may be any suitable computing device, such as, for example, a computer 20 as described in FIG. 7, or component thereof, for implementing efficient domain model generation. The computing device 100 may be a single computing device, or may include multiple connected computing devices, and may be, for example, a laptop, a desktop, an individual server, a server cluster, a server farm, or a distributed server system, or may be a virtual computing device or system, or any suitable combination of physical and virtual systems. The computing device 100 may be part of a computing system and network infrastructure, or may be otherwise connected to the computing system and network infrastructure, including a larger server network which may include other server systems similar to the computing device 100. The computing device 100 may include any suitable combination of central processing units (CPUs), graphical processing units (GPUs), and tensor processing units (TPUs). For example, the computing device 100 may be, or be part of, a cloud computing sever system that may be a multi-tenanted server system.

The computing device 100 may include a query generator 110. The query generator 110 may be any suitable combination of hardware and software of the computing device 100 for implementing a system that may be able to determine a domain indicated in a user request and generate queries to be run against a domain knowledge repository to retrieve data relevant to the domain. The query generator 110 may receive user requests that may request the generation of a domain model for a domain along with customizations for the domain model. The query generator 110 may be, for example, an LLM that may accept user requests written in natural language and may determine the intent of the user request, including the domain for which the user wants a domain model to be generated. The query generator 110 may determine the domain in any suitable manner, including through direct specification in the user request or through interpretation of the user request if the domain is not directly identified in the user request. The query generator 110 may, for example, determine which domain for which data exists in electronic documents 172 in domain knowledge repository 171 best matches a domain explicitly specified or inferred from the user request. The query generator 110 may generate any number of queries to be run against the domain knowledge repository 171. The queries may be generated to retrieve data from the electronic documents 172 that is relevant to the domain determined from the user request, taking into account customizations specified in the user request. The queries may be generated as natural language queries that may be suitable for input to a machine learning system such as an LLM.

The computing device 100 may include a domain model generator 120. The domain model generator 120 may be any suitable combination of hardware and software of the computing device 100 for running queries against the domain knowledge repository 171 and using data received in response to the queries to generate a domain model. The domain model generator 120 may receive data for a domain model by running queries generated by the query generator 110 against the domain knowledge repository 171. The domain model generator 120 may be, for example, a machine learning system such as an LLM. The domain model generator 120 may receive data responsive to the queries from the electronic documents 172 in the domain knowledge repository 171 in response to the running of the queries. The domain model generator 120 may generate the domain model from the data for the domain model by performing one or more formatting steps and transformation steps on the data for the domain model. The domain model generator 120 may output the domain model in any suitable format, including, for example, plain text format or JSON format. The generated domain model may include, for example, business entities and their related documentation, entity attributes, attribute data types, attribute constraints such as whether attributes are unique or not null, entity relationships which may indicated through the use of foreign keys, and relationship cardinality. The domain model generator 120 may also generate suggested updates to already-existing domain models, such as those stored with the domain models 175, when new or updated electronic documents are added to the electronic documents 172 in the domain knowledge repository 171.

The storage 170 may be any suitable combination of hardware and software for storing data. The storage 170 may include any suitable combination of volatile and non-volatile storage hardware and may include components of the computing device 100 and hardware accessible to the computing device 100, for example, through wired and wireless direct or network connections. The storage 170 may store the domain knowledge repository 171, which may be a repository storing the electronic documents 172. The electronic documents 172 may be electronic documents in any suitable formats that may include data relevant to any number of domains. The electronic documents 172 may be found and added to the domain knowledge repository 171 in any suitable manner, including through automatic searching or crawling available sources of electronic documents and through being added by subject matter experts. The storage 170 may store the domain models 175, which may be domain models, or copies thereof, generated by the domain model generator 120. Domain models generated by the domain model generator 120 may be sent to other computing devices outside of the computing device 100 to be incorporated into software construction and implementation.

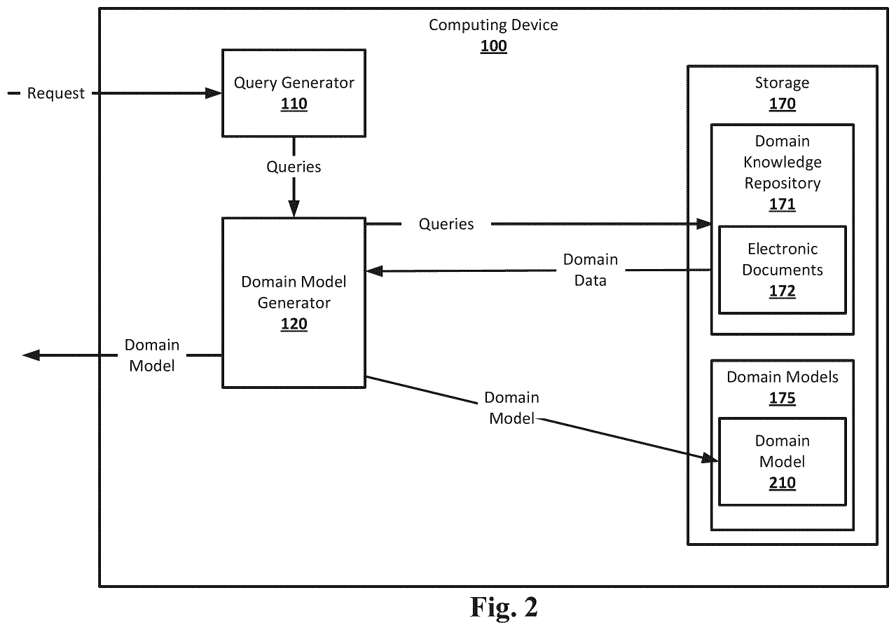

FIG. 2 shows an example arrangement suitable for efficient domain model generation according to an implementation of the disclosed subject matter. A request may be received as input at the query generator 110. The request may be, for example, a natural language request received from a user that requests the generation of a domain model with specified customizations. The user request may explicitly specify the domain for which the domain model should be generated, or the query generator 110 may interpret the user request to determine which domain the domain should be generated for. The query generator 110 may, for example, determine a domain from among the domains for which there is data in the electronic documents 172 of the domain knowledge repository 171. The query generator 110 may generate queries that may be run against the domain knowledge repository 171 to retrieve data that may be used to generate a domain model for the domain from the user request. The queries may also take into account any customizations to the domain model specified in the user request, such as a geographic localization for the domain model. The queries may be sent to the domain model generator 120.

The domain model generator 120 may receive the queries from the query generator 110 and run them against the domain knowledge repository 171. In response to running the queries against the domain knowledge repository 171, the domain model generator 120 may receive data relevant to the domain, adjusted for specified customizations, from the user request from the electronic documents 172 of the domain knowledge repository 171. The domain model generator 120 may generate a domain mode for the domain from the user request using the data received from the domain knowledge repository 171. The domain model generator 120 may output the domain model in any suitable format, including, for example, plain text format or JSON format. The generated domain model may include, for example, business entities and their related documentation, entity attributes, attribute data types, attribute constraints such as whether attributes are unique or not null, entity relationships which may indicated through the use of foreign keys, and relationship cardinality. The domain model generator 120 may store the generated domain model as the domain model 210 in the domain models 175. The domain model generator 120 may send generated domain model to the user who submitted the user request to the query generator 110 so that the user may review the domain model and either use the domain model or provide an indication that the domain model is incorrect.

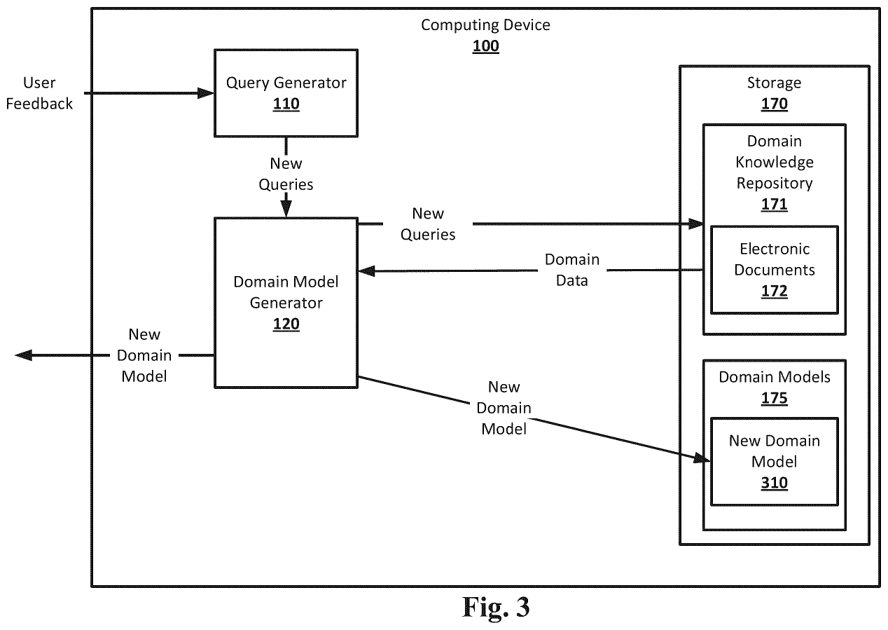

FIG. 3 shows an example arrangement suitable for efficient domain model generation according to an implementation of the disclosed subject matter. The query generator 110 may receive user feedback from a user for a domain model, for example, the domain model 210, generated by the domain model generator 120 and sent to the user. The user feedback may be written in natural language and may include an indication that the domain model sent to the user is incorrect and a specification of the reason the user believes the domain model to be incorrect. The query generator 110 may generate new queries based on the user feedback about the domain model and the user request that was used to generate the domain model. The domain model generator 120 may run the new queries against the domain knowledge repository 171 and receive in response data, from the electronic documents 172, that is relevant to the domain from the user request taking into account customizations specified in the user request and the reasons the previously generated domain model was considered incorrect by the user as specified in the user feedback. This may ensure that the new domain model generated from the data by the domain model generator 120 corrects the issues that caused the user to believe the previously generated domain model was incorrect. For example, the user may have indicated that the previously generated domain model was incorrect due to including data that did not belong in the domain model. The new queries generated by the query generator 110 may be generated so that when the new queries are run against the domain knowledge repository 171, the data that the user indicates does not belong in the domain model is excluded from the data received by the domain model generator 120 and thus does not appear in the new domain model. The domain model generator 120 may output the new domain model, which may be stored as, for example, the new domain model 310, and may be sent back to the user to be reviewed. The user may then use the new domain model, for example, in software construction or implementation, or may provide user feedback indicating that the new domain model is incorrect, resulting in the generation of new queries and the generation of another new domain model. This feedback loop may continue until the user receives a domain model they consider to be correct and does not provide user feedback indicating that the domain model is incorrect.

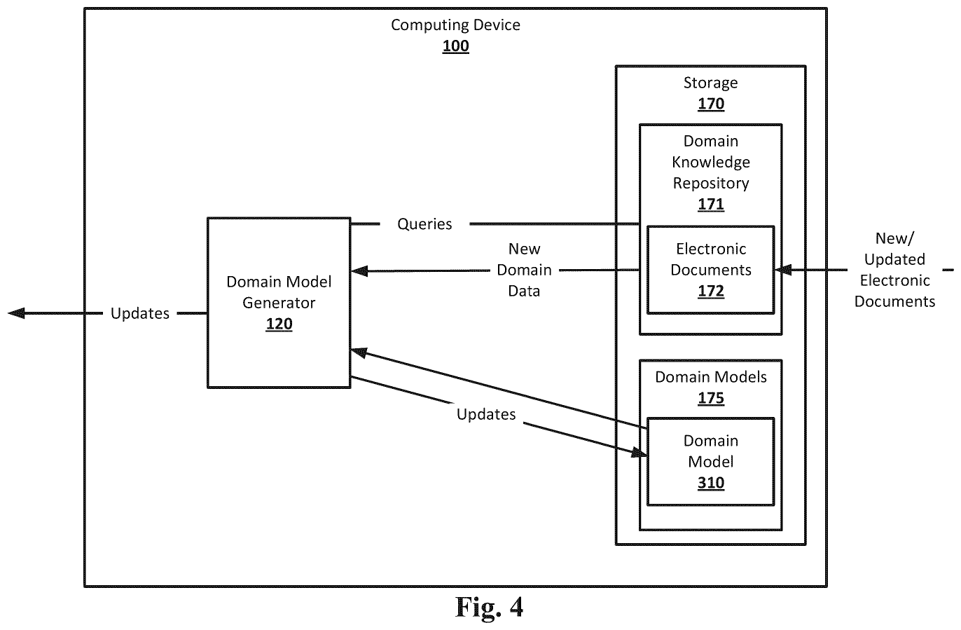

FIG. 4 shows an example arrangement suitable for efficient domain model generation according to an implementation of the disclosed subject matter. New and/or updated electronic documents including data relevant to domains may be added to the electronic documents 172 in the domain knowledge repository 171. The domain model generator 120 may run queries against the domain knowledge repository 171 that may request any new or updated data from the new or updated electronic documents that is relevant to domains for which a domain model, such as the domain model 310, has already been generated. The domain model generator 120 may run queries requesting new or updated data for domains at any suitable interval or based on any suitable event. For example, the domain model generator 120 may run queries requesting new or updated data for domains whenever new and/or updated electronic documents are added to the electronic documents 172. The domain model generator 120 may use the new or updated data for a domain received in response to the queries to generate suggested updates for the domain models generated for that domain. The suggested update may be generated in any suitable manner, including, for example, through comparison of the new or updated data to the data of the domain model for which the suggested update is being generated. The domain model generator 120 may use the generated suggested updates in any suitable manner. For example, the domain model generator 120 may apply suggested updates directly to any domain models stored in the storage 170 with the domain models 175, ensuring that the domain models stay updated. The domain model generator 120 may also send suggested updates to users who previously received domain models so that the users may decide whether to apply the suggested updates to their own copies of the domain model. This may allow already-existing domain models to be updated as new data relevant to their domains is added to the domain knowledge repository 171 in the form of new and/or updated electronic documents.

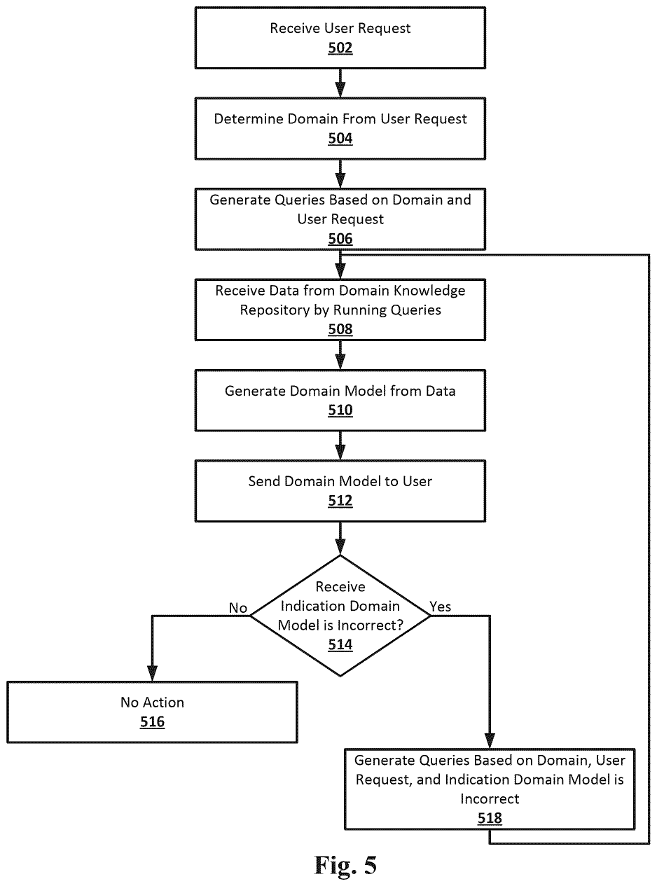

FIG. 5 shows an example procedure suitable for efficient domain model generation according to an implementation of the disclosed subject matter. At 502, a user request may be received. For example, a user request that requests the generation of a domain model for a domain with specified customizations may be received from a user at the query generator 110. The user request may be text in natural language.

At 504, a domain may be determined from the user request. For example, the user request may directly specify the domain for which the domain model should be generated, or the query generator 110 may interpret the user request to determine the domain for which the domain model should be generated based on domain for which there is data in the electronic documents 172 of the domain knowledge repository 171.

At 506, queries may be generated based on the domain and the user request. For example, the query generator 110 may generate queries to be run against the domain knowledge repository 171 based on the determined domain and any customizations specified in the user request. The queries may be generated so that the response when the queries are run against the domain knowledge repository 171 includes data relevant to the determined domain taking into account any customizations specified in the user request and does not include data that is either not relevant to the domain or is relevant but should be excluded based on the customizations, for example, data relevant to the domain generally but not to the domain in a specific geographic region specified in the customizations.

At 506, data may be received from the domain knowledge repository by running the queriers. For example, the domain model generator 120 may receive the queries from the query generator 110 and run the queries against the domain knowledge repository 171. In response to running the queries, the domain model generator 120 may receive data from the electronic documents 172 that is responsive to the queries, for example, data relevant to the determined domain and not excluded by any of the customizations specified in the user request.

At 508, a domain model may be generated from the data. For example, the domain model generator 120 may use the data received in response to running the queries against the domain knowledge repository 171 to generate a domain model for the determined domain from the user request. The generated domain model may include the data from the electronic documents 172 that is relevant to the domain and not excluded due to customizations in the user request, as this may be the data received in response to running the queries against the domain knowledge repository 171. The domain model generator 120 may generate and output the domain model in any suitable format including, for example, plain text format or JSON format. The generated domain model may include, for example, business entities and their related documentation, entity attributes, attribute data types, attribute constraints such as whether attributes are unique or not null, entity relationships which may indicated through the use of foreign keys, and relationship cardinality.

At 512, the domain model may be sent to the user. For example, the domain model generator 120 may send the generated domain model to the user who submitted to the query generator 110 the user request that requested the generation of the domain model. The domain model generator 120 may also store the domain model, for example, storing the domain model 210 with the domain models 175 in the storage 170.

At 514, if an indication that the domain model is incorrect is received, flow may proceed to 518. Otherwise, flow may proceed to 516. For example, the user may review the domain model received from the domain model generator 120 to determine if the domain model is correct and can be used as intended, for example, in software construction or implementation. If the domain model is correct, the user may provide feedback to the computing device 100 including an indication that the domain is correct or may provide no feedback. If the user believes the domain model is incorrect, the user may provide feedback to computing device 100 including an indication that the domain model is incorrect with the reason for the determination that the domain model is incorrect.

At 516, no action may be taken. For example, the user may have provided feedback to the computing device 100 that the domain model received from the domain model generator 120 is correct, or the user may have provided no feedback of any kind. This may indicate that the domain model is correct, for example, was generated for the correct domain, took into account the customizations specified in the user request, included correct data and relationships, and was not missing data or relationships that the user expected to be included in the domain model. The domain model generator 120 may take no further action. The user may use the domain model in software construction or implementation.

At 518, queries may be generated based on the domain, the user request, and the indication that the domain model is incorrect. For example, the user may have sent feedback to the computing device 100 indicating that the domain model sent to the user is incorrect and the reasons for the incorrectness. The feedback may be in the form of text in natural language. The query generator 110 may use the feedback to generate new queries to be run against the domain knowledge repository 171. The new queries may be generated so that the response when the new queries are run against the domain knowledge repository 171 includes data relevant to the determined domain taking into account any customizations specified in the user request and the reason the domain model sent to the user was indicated to be incorrect and does not include data that is either not relevant to the domain or is relevant but should be excluded based on the customizations or based on the reason the user indicated the domain model was incorrect. For example, if the feedback from the user indicated that the domain model was incorrect because it included data that was only relevant to the domain in a different geographic area than the one where the user will be using the domain model, the query generator 110 may generate queries that exclude this data from the response to the queries. If the feedback from the user indicated that the domain model was incorrect because it did not include data that the user expected to be in the domain model, the query generator 110 may generate queries to include this data in the response to the queries. Flow may then proceed back to 508, where data may be received by the domain model generator 110 by running the newly generated queries may be run against the domain knowledge repository, then to 510 where a new domain model may be generated from this data, 512 where the new domain model may be sent to the user, and 514, where the user may again provide feedback indicating the correctness or incorrectness of the domain model or provide no feedback which may be considered an indication of the correctness of the domain model. If the domain model again indicated to be incorrect, flow may proceed back to 518 again. This may continue until the user receives a domain model that they consider to be correct.

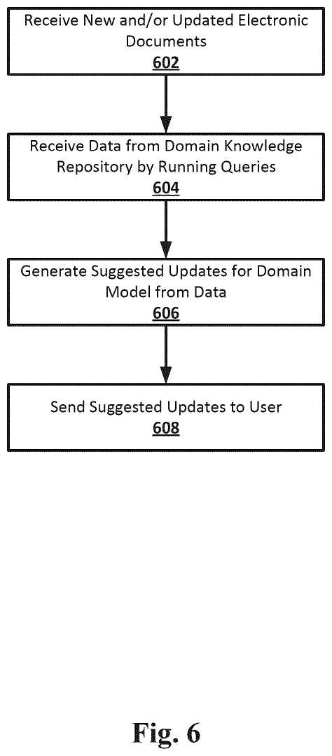

FIG. 6 shows an example procedure suitable for efficient domain model generation according to an implementation of the disclosed subject matter. At 602, new and or updated electronic documents may be received. For example, new and/or updated electronic documents may be received at the domain knowledge repository 171 and added to the electronic documents 172. The new and/or updated electronic documents may be received in any suitable manner. For example, the new and/or updated electronic documents may be received based on crawling or searching of available sources of electronic documents or may be added to the domain knowledge repository 171 by subject matter experts. The new and/or updated electronic documents may include data relevant to any number of domains.

At 604, data may be received from the domain knowledge repository by running the queriers. For example, the domain model generator 120 may run queries designed to retrieve updated data for domains for already-existing domain models against the domain knowledge repository 171. In response to running the queries, the domain model generator 120 may receive data from the electronic documents 172 that is responsive to the queries, for example, new or updated data relevant domain models that have already been generated by the domain model generator 120 and sent to users. The domain model generator 120 may run queries designed to retrieve updated data for already-existing domain models at any suitable times and intervals.

At 606, suggested updates for the domain model may be generated. For example, the domain model generator 110 may use data received from the domain knowledge repository 171 as a response to running a query designed to retrieve updated data for a domain for an already-existing domain model to generate suggested updates for the already-existing domain model. The suggested updates may, for example, add new data and relationships to the domain model or modify data and relationships in the domain model, or remove data or relationships from the domain model based on new data for the domain from the new and/or updated electronic documents.

At 608, suggested updates may be sent to a user. For example, the suggested updates generated for a domain model may be sent to the user whose user request caused the generation of that domain model and who received that domain model from the domain model generator 120. The user may then choose whether or not to apply the suggested update to their copy of the domain model. The domain model generator 120 may also apply the update directly to a copy of the domain model stored with the domain models 175.

Implementations of the presently disclosed subject matter may be implemented in and used with a variety of component and network architectures. FIG. 7 is an example computer 20 suitable for implementing implementations of the presently disclosed subject matter. As discussed in further detail herein, the computer 20 may be a single computer in a network of multiple computers. As shown in FIG. 7, computer may communicate a central component 30 (e.g., server, cloud server, database, etc.). The central component 30 may communicate with one or more other computers such as the second computer 31. According to this implementation, the information obtained to and/or from a central component 30 may be isolated for each computer such that computer 20 may not share information with computer 31. Alternatively or in addition, computer 20 may communicate directly with the second computer 31.

The computer (e.g., user computer, enterprise computer, etc.) 20 includes a bus 21 which interconnects major components of the computer 20, such as a central processor 24, a memory 27 (typically RAM, but which may also include ROM, flash RAM, or the like), an input/output controller 28, a user display 22, such as a display or touch screen via a display adapter, a user input interface 26, which may include one or more controllers and associated user input or devices such as a keyboard, mouse, WiFi/cellular radios, touchscreen, microphone/speakers and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 enable data communication between the central processor 24 and the memory 27, which may include read-only memory (ROM) or flash memory (neither shown), and random access memory (RAM) (not shown), as previously noted. The RAM can include the main memory into which the operating system and application programs are loaded. The ROM or flash memory can contain, among other code, the Basic Input-Output system (BIOS) which controls basic hardware operation such as the interaction with peripheral components. Applications resident with the computer 20 can be stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may enable the computer to communicate with other computers via one or more local, wide-area, or other networks, as shown in FIG. 8.

Many other devices or components (not shown) may be connected in a similar manner (e.g., document scanners, digital cameras and so on). Conversely, all of the components shown in FIG. 7 need not be present to practice the present disclosure. The components can be interconnected in different ways from that shown. The operation of a computer such as that shown in FIG. 7 is readily known in the art and is not discussed in detail in this application. Code to implement the present disclosure can be stored in computer-readable storage media such as one or more of the memory 27, fixed storage 23, removable media 25, or on a remote storage location.

FIG. 8 shows an example network arrangement according to an implementation of the disclosed subject matter. One or more clients 10, 11, such as computers, microcomputers, local computers, smart phones, tablet computing devices, enterprise devices, and the like may connect to other devices via one or more networks 7 (e.g., a power distribution network). The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15. Information from or about a first client may be isolated to that client such that, for example, information about client 10 may not be shared with client 11. Alternatively, information from or about a first client may be anonymized prior to being shared with another client. For example, any client identification information about client 10 may be removed from information provided to client 11 that pertains to client 10.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A computer-implemented method comprising:
receiving into a domain knowledge repository electronic documents comprising data associated with one or more domains;
receiving a user request to generate a domain model;
determining, based on the user request, a domain of the one or more domains for which to generate the domain model;
generating one or more queries to be run against the domain knowledge repository based on the determined domain;
receiving data for the domain model by running the one or more queries against the domain knowledge repository using a machine learning system;
generating the domain model from the data for the domain model by performing one or more formatting steps and transformation steps on the data for the domain model using the machine learning system;
receiving in the domain knowledge repository additional electronic documents;
generating at least one suggested update to the domain model based on the additional electronic documents; and
applying the at least one suggested update to the domain model.

2. The computer-implemented method of claim 1, further comprising:
sending the domain model to the user;
receiving from the user an indication that the domain model is incorrect; and
generating an updated model based on the domain model and the indication that the domain model is incorrect.

3. (canceled)

4. The computer-implemented method of claim 1, wherein determining, based on the user request, a domain of the one or more domains for which to generate the domain model further comprises determining domains for which electronic documents in the domain knowledge repository comprise relevant data.

5. The computer-implemented method of claim 1, wherein generating the domain model from the data for the domain model by performing one or more formatting steps and transformation steps on the data for the domain model using the machine learning system is further based on a geographic locality of the domain model specified in the user request.

6. The computer-implemented method of claim 1, wherein the user request comprises one or more customizations for the domain model.

7. The computer-implemented method of claim 1, wherein the domain model is in plain text file format or a JSON file format.

8. A computer-implemented system comprising:
one or more storage devices; and
a processor that receives into a domain knowledge repository electronic documents comprising data associated with one or more domains,
receives a user request to generate a domain model,
determines, based on the user request, a domain of the one or more domains for which to generate the domain model,
generates one or more queries to be run against the domain knowledge repository based on the determined domain,
receives data for the domain model by running the one or more queries against the domain knowledge repository using a machine learning system,
generates the domain model from the data for the domain model by performing one or more formatting steps and transformation steps on the data for the domain model using the machine learning system,
receives in the domain knowledge repository additional electronic documents,
generates at least one suggested update to the domain model based on the additional electronic documents, and
applies the at least one suggested update to the domain model.

9. The computer-implemented system of claim 8, wherein the processor further sends the domain model to the user,
receives from the user an indication that the domain model is incorrect, and
generates an updated model based on the domain model and the indication that the domain model is incorrect.

10. (canceled)

11. The computer-implemented system of claim 8, wherein the processor determines, based on the user request, a domain of the one or more domains for which to generate the domain model by determining domains for which electronic documents in the domain knowledge repository comprise relevant data.

12. The computer-implemented system of claim 8, wherein the processor generates the domain model from the data for the domain model by performing one or more formatting steps and transformation steps on the data for the domain model using the machine learning system based on a geographic locality of the domain model specified in the user request.

13. The computer-implemented system of claim 8, wherein the user request comprises one or more customizations for the domain model.

14. The computer-implemented system of claim 8, wherein the domain model is in plain text file format or a JSON file format.

15. A system comprising: one or more computers and one or more non-transitory storage devices storing instructions which are operable, when executed by the one or more computers, to cause the one or more computers to perform operations comprising:
receiving into a domain knowledge repository electronic documents comprising data associated with one or more domains;
receiving a user request to generate a domain model;
determining, based on the user request, a domain of the one or more domains for which to generate the domain model;
generating one or more queries to be run against the domain knowledge repository based on the determined domain;
receiving data for the domain model by running the one or more queries against the domain knowledge repository using a machine learning system;
generating the domain model from the data for the domain model by performing one or more formatting steps and transformation steps on the data for the domain model using the machine learning system;
receiving in the domain knowledge repository additional electronic documents;
generating at least one suggested update to the domain model based on the additional electronic documents; and
applying the at least one suggested update to the domain model.

16. The system of claim 15, wherein the instructions are operable, when executed by the one or more computers, to further cause the one or more computers to perform operations comprising:
sending the domain model to the user;
receiving from the user an indication that the domain model is incorrect; and
generating an updated model based on the domain model and the indication that the domain model is incorrect.

17. (canceled)

18. The system of claim 15, wherein the instructions which are operable, when executed by the one or more computers, to cause the one or more computers to perform operations comprising determining, based on the user request, a domain of the one or more domains for which to generate the domain model further cause the one or more computers to perform operations comprising determining domains for which electronic documents in the domain knowledge repository comprise relevant data.

19. The system of claim 15, wherein generating the domain model from the data for the domain model by performing one or more formatting steps and transformation steps on the data for the domain model using the machine learning system is further based on a geographic locality of the domain model specified in the user request.

20. The system of claim 15, wherein the user request comprises one or more customizations for the domain model.
